(19) United States
(12) Patent Application Publication
(10) Pub. No.: US 2003/0115211 A1
(43) Pub. Date: Jun. 19, 2003

(54) Spatial intelligence system and method

(75) Inventors: Li-Wen Chen, Cupertino, CA (US); Victor Luu, Morgan Hill, CA (US)

Correspondence Address: Paul A. Durdik, Squire, Sanders & Dempsey LLP, 600 Hansen Way, Palo Alto, CA, 94304, US

(73) Assignee: MetaEdge Corporation, Sunnyvale, CA (US)

(21) Appl. No.: 10/017,701

(22) Filed: Dec. 14, 2001

(51) Int. Cl. G06F 7/00

(52) U.S. Cl. 707/102; 707/104.1

(57) ABSTRACT

The present invention provides techniques for analyzing and managing information having a spatial component. Techniques such as virtual schemas can be used to create meta models for analyzing spatial information, in conjunction with information about other centric entities, including business entities, technical entities, and governmental entities. Specific embodiments provide systems, methods, computer programs and apparatus for populating databases in accordance with the defined meta models and analyzing information having spatial components in a variety of business, technical and governmental applications.

### CROSS REFERENCE TO RELATED APPLICATIONS

The present application claims the benefit of U.S. Provisional Patent Application Serial No. ______, entitled “Spatial Intelligence,” by Li-Wen Chen and Victor Luu, filed, Oct. 29, 2001, which is fully incorporated herein by reference.

### BACKGROUND OF THE INVENTION

The present invention relates generally to techniques for analyzing information, and in particular to techniques for analyzing relationships among information entities using spatial presentations.

A significant amount of information managed and processed by decision makers contains a spatial component. Such spatial data is not, however, merely the concern of geographers or mapmakers. Rather, the term “spatial information” refers to any information in which distance or positional relationships, implicit or explicit, are incorporated within. Spatial functioning mental processes within our brains interpret visual components of information in pictures, maps, plans and the like, providing us with an understanding of the world based in part upon these spatial information components. Without the ability to comprehend and interpret visual information something as apparently straightforward as remembering how to get to the front door of a house from the living room would not be possible. Scientists have named this comprehension “spatial intelligence.” Some scientists have extended the notion of spatial intelligence even further, suggesting that our spatial intelligence provides the ability to convey a sense of the “whole” of a subject, a “gestalt” organization, different from a logical-mathematical kind of organization. These scientists believe that the human ability to impart a non-logical wholeness to form, may be a function of our spatial intelligence.

Conventional approaches for managing spatial information include geographic information systems (GIS), which provide automated map management applications. Conventional GIS systems employ geocoding, a software technique for drawing dots on a digital map based upon digitally represented information.

While certain advantages to conventional approaches are perceived, opportunities for further improvement exist. For example, many conventional GIS systems merely automate map management applications. Such conventional applications focus on providing an attractive “front-end” for displaying spatial information to the viewer. While the resulting diagrams depict spatial information, users could further benefit from methods heretofore unknown that could provide depictions resulting from performing further analysis on spatial information, rather than merely presenting the raw spatial information in an attractive format.

What is needed are improved techniques for analyzing and managing information, especially information having a spatial component.

### SUMMARY OF THE INVENTION

The present invention provides techniques for analyzing and managing information having a spatial component. Techniques such as virtual schemas can be used to create meta models for analyzing spatial information, in conjunction with information about other centric entities, including business entities, technical entities, and governmental entities. Specific embodiments provide systems, methods, computer programs and apparatus for populating databases in accordance with the defined meta models and analyzing information having spatial components in a variety of business, technical and governmental applications.

In a representative embodiment of the present invention, a method is provided. The method comprises receiving a first schema database. Forming a virtual schema including at least a portion of a dataset included within the first database is also part of the method. The method also includes receiving a first input indicating a criterion. Aggregating data of the database into one or more groupings in accordance with the virtual schema and the first input indicating the criteria is also part of the method. The method includes displaying one or more indicators associated with the one or more groupings on an n-dimensional presentation.

In a specific embodiment, the present invention provides a customer data analysis report produced according to the method.

In select embodiments, the method further comprises receiving a second input indicating one or more regions; storing the second input as a spatial-object meta data; and aggregating the groupings based upon the spatial-object meta data. Displaying one or more indicators associated with the one or more groupings in a region associated therewith on an n-dimensional presentation can also be part of the method in some embodiments. The n-dimensional presentation can be a map, for example. Displaying one or more indicators can include determining an x, y coordinate for each region on the map and displaying at least one indicator associated with the one or more groupings on the map at the x, y coordinate. The regions comprise at least one of a polygon, a circle, a rectangle, an ellipse, and an animal home range, for example.

The second input indicating one or more regions can comprise any of an input from a user, a pre-determined area, a derivation based upon one or more objects on the n-dimensional presentation, and a result of a computation. The pre-determined area can comprise any of a zip code, an area code, a census tract, a Metropolitan Statistical Area (MSA), a nation state, a state, a county, a municipality, a latitude, and a longitude. The derivation based upon one or more objects on the n-dimensional presentation can be a region within a specified distance of a power line, for example. The result of a computation can comprise computing an animal home range, the home range providing a region defined by activities of a target; defining within the region a first ellipse; and defining within the region a second ellipse approximately orthogonal to the first ellipse so that an area defined by intersection of the first ellipse and the second ellipse provides a greatest probability of finding the target in specific embodiments. The target can comprise a variety of persons or things. For example, a suspect who perpetrated criminal acts defined by the data, a customer who completed transactions in shops defined by the data, or a source of biological material that caused infections in persons defined by the data can be a target.

In specific embodiments, the groupings may be aggregated based upon the spatial-object meta data by checking whether data points fall within a common region. If so, the data represented by the data points may be aggregated together. Specific embodiments can thereby provide maps of averaged values, density values, and the like.

In specific embodiments, the method can also include redefining the virtual schema based upon the spatial-object meta data. A third input indicating one or more redefined regions is received. The third input is stored as redefined spatial-object meta data. Then, the information can be aggregated into new groupings based upon the spatial-object meta data.

In select embodiments, the method also includes redefining the virtual schema based upon the spatial-object meta data. Receiving a third input indicating a criterion is also part of the method. The method can include aggregating data of the database into one or more new groupings in accordance with the redefined virtual schema and the third input indicating the criteria. Further, displaying one or more indicators associated with the one or more new groupings on an n-dimensional presentation. Specific embodiments can thereby provide maps with user defined regions, and the like.

In specific embodiments, the method also includes receiving a third input indicating a relationship between a first data point and a second data point on the n-dimensional presentation. Reflecting the relationship in the virtual schema is also part of the method. The method can also include aggregating data of the database into one or more new groupings in accordance with the virtual schema and displaying one or more indicators associated with the one or more new groupings on an n-dimensional presentation. Specific embodiments can thereby provide maps of proximities, and the like.

In specific embodiments, the method further comprises receiving a second database. A virtual schema including at least a portion of a dataset included within the first database, the second database, or both is formed. The method also includes receiving a first input indicating a criterion. Aggregating data of the first database, the second database, or both, into one or more groupings in accordance with the virtual schema and the first input indicating the criteria is also part of the method. The method can include displaying one or more indicators associated with the one or more groupings on an n-dimensional presentation. In some embodiments, the method also includes generating code in accordance with the virtual schema. In select embodiments, the method further comprises providing customer centric information to a core of customer data within the database in accordance with the virtual schema. Specific embodiments can thereby provide maps of information derived from a plurality of sources, and the like.

In another representative embodiment of the present invention, a method is provided. The method comprises receiving a first schema database. A virtual schema that includes at least a portion of a dataset included within the first database is formed. The method also includes receiving a first input indicating a criterion. A second input indicating one or more regions may be received. The method also includes aggregating data of the database into one or more groupings in accordance with the virtual schema, the first input indicating the criteria, and the second input indicating the one or more regions of interest and displaying one or more indicators associated with the one or more groupings on an n-dimensional presentation. Specific embodiments can thereby provide maps of information based upon user defined regions, and the like.

In a further representative embodiment of the present invention, a system is provided. The system comprises a schema builder that generates one or more virtual schemas including at least a portion of data input from a source, and generates mapping rules controlling data movement into a data warehouse. A metadata repository holds the virtual schemas and mapping rules. A data warehouse builder, a spatial-object data repository, a region checker and an n-dimensional presentation mechanism are also part of the system. The data warehouse is defined by at least a portion of the data input, the virtual schemas, the mapping rules, and the analysis functions.

In a representative embodiment of the present invention, an apparatus is provided. The apparatus comprises a means for generating one or more virtual schemas including at least a portion of data input from a source. The apparatus also includes means for generating mapping rules controlling data movement into a data warehouse and means for holding the virtual schemas and mapping rules. Means for generating one or more analysis functions based upon the virtual schemas and data input are also part of the apparatus.

In a yet further representative embodiment of the present invention, a computer program product is provided. The computer program product comprises a computer readable storage medium holding program code. The program product further includes code for providing a user interface. Code for generating customer data analysis function code is also included in the program product. As is code for scheduling tasks for managing a data warehouse. The program product also includes code for pre-processing data for movement into the data warehouse and code for managing creation of the data warehouse. Code for defining customer data analysis functions can be part of the program product also. The program product can also include code for performing data source analysis and code for planning operations of a customer data analysis environment.

In a still further representative embodiment of the present invention, a computer program product is provided. The computer program product comprises a computer readable storage medium holding program code. The program product further includes code for accessing meta data from a repository. Code for translating entities from a meta model into a data schema to form a database is also part of the computer program product. Code for providing customer activity correlation queries with access to a database of a data warehouse can be included in the program product as well. The program product also includes code for providing customer data analysis functions and code for providing analysis results to at least one of a plurality of business applications.

In a still yet further representative embodiment of the present invention, a method is provided. The method includes providing a focal group. The focal group can include at least one of a plurality of core components and at least one of a plurality of classification components providing classifications for information relating to the core components. The method also includes providing at least one customized group. The customized group can include at least one of a plurality of customer activity components related to the core component and at least one of a plurality of activity lookup components related to at least one of the customer activity components. The focal group and the customized group comprise a reverse star schema meta model.

Numerous benefits are achieved by way of the present invention over conventional techniques. Specific embodiments provide spatial intelligence aware infrastructure in which spatial entities and attributes may be used in conjunction with data warehousing and data mining techniques to provide insight into business, technical, and governmental processes. Specific embodiments according to the present invention bring spatial data into the mainstream business world, the data warehousing environment, and decision-support systems environments. Data warehousing applications in accordance with specific embodiments of the present invention can transform data into useful knowledge and intelligence. The introduction of spatial data in specific embodiments can enable business analyst and other decision makers to build up analytic values, gaining advantage with respect to competitors, for example.

These and other benefits are described throughout the present specification. A further understanding of the nature and advantages of the invention herein may be realized by reference to the remaining portions of the specification and the attached drawings.

### BRIEF DESCRIPTION OF THE DRAWINGS

FIGS. 1A-IF illustrate conceptual drawings of representative spatial analyses in specific embodiments of the present invention.

FIGS. 2A-2B illustrate representative systems capable of embodying spatial analysis applications in specific embodiments of the present invention.

FIG. 3 illustrates a block diagram of a representative computer system in a specific embodiment of the present invention.

FIGS. 4A-4D illustrate representative types of information in a specific embodiment of the present invention.

FIGS. 5A-5C illustrate representative types of information in a specific embodiment of the present invention.

FIGS. 6A-6E illustrate flowcharts of representative processes in specific embodiment of the present invention.

FIG. 7 illustrates a conceptual diagram of a representative database in a specific embodiment of the present invention.

FIG. 8 illustrates a conceptual diagram of a representative user interface screen in a specific embodiment of the present invention.

FIGS. 9A-9B illustrate representative example map presentation in a specific embodiment of the present invention.

FIG. 10 illustrates a mapping of crime locations in a specific embodiment of the present invention.

FIG. 11 illustrates a mapping of a crime density in a specific embodiment of the present invention.

FIG. 12 illustrates a mapping of a combination of data from a plurality of sources in a specific embodiment of the present invention.

FIG. 13 illustrates a mapping of Hot Spots in a specific embodiment of the present invention.

FIG. 14 illustrates a proximity mapping in a specific embodiment of the present invention.

### DESCRIPTION OF THE SPECIFIC EMBODIMENTS

The present invention provides techniques for analyzing and managing information having a spatial component. Techniques such as virtual schemas can be used to create meta models for analyzing spatial information, in conjunction with information about other centric entities, including business entities, technical entities, and governmental entities. Specific embodiments provide systems, methods, computer programs and apparatus for populating databases in accordance with the defined meta models and analyzing information having spatial components in a variety of business, technical and governmental applications.

A number of terms will be defined in order to assist the reader in understanding the embodiments of the present invention described. As used herein, the term “information” refers to data, raw or processed, that can be stored in a database, data mart, or data warehouse, for example. The term “intelligence” refers to an understanding developed from information, for example. As used herein, the term “spatial intelligence” refers to visualizing and understanding proximity relationships within information. Such relationships arise from positions and/or distances between events, persons or things. Spatial intelligence can provide enhanced understanding of information to users in a variety of business, technical or governmental fields.

The term, “spatial entities” includes, for example, a store, an oil well, an ATM machine, a Police Beat, a County, a Customer, a Sales Region, and the like. The term, “spatial attributes” is used to refer to a descriptive characteristic about the entity. For spatial analysis applications, spatial attributes include, for example, an Address, a City, a Zip Code, a State, a Country, a Census Tract, a Metropolitan Statistical Area (MSA), a Latitude, a Longitude, and the like.

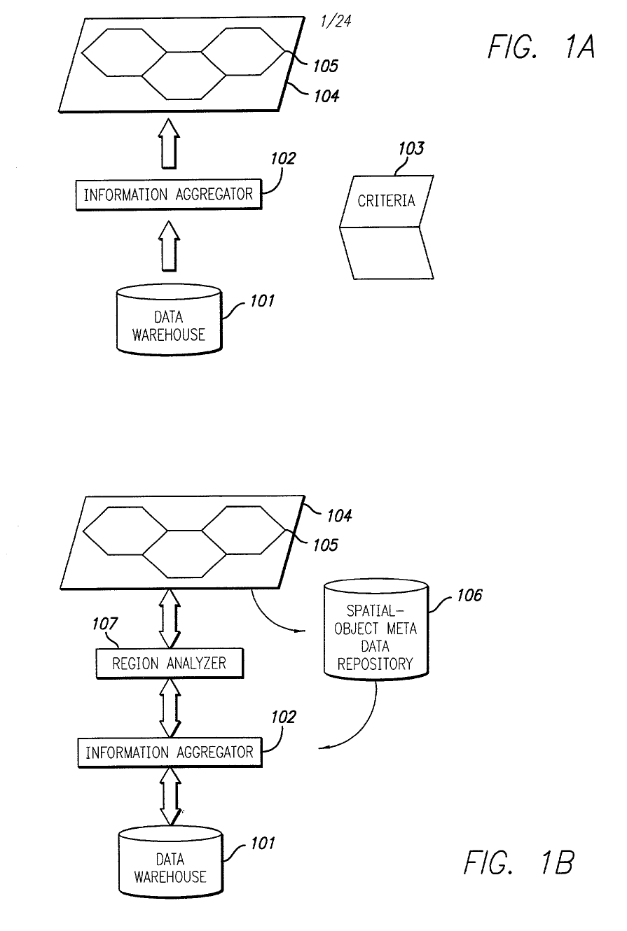

FIGS. 1A-1B illustrate conceptual drawings of representative spatial analyses in specific embodiments of the present invention. As illustrated by FIG. 1A, data from a data warehouse 101 is provided to an information aggregator 102. The information aggregator 102 aggregates information from the data warehouse 101 subject to a criterion 103 for display on an n-dimensional presentation area 104. Criterion is broadly defined as any expression of a subject or topic of interest upon which intelligence may be developed by one or more users. In various embodiments, criteria can include particular regions of interest, parameters of interest against which intelligence may be developed from information. For example, what is my profitablity per customer by sales region?, what percentage of crimes in my neighborhood are drug or alcohol related?, and so forth, are some of the many different criteria which can be provided in specific embodiments. In a specific embodiment, C-INSight™ a product of MetaEdge Corporation, of Sunnyvale, Calif., provides the capability to dynamically derive attributes and profiles from static data and virtual schemas to create a star schema database, and, hence a multidimensional geographic display of the static data, dynamically. Reference maybe had to a commonly owned copending U.S. patent application Ser. No. 09/306,677, entitled, “Method For Providing A Reverse Star Schema Model,” to Li-Wen Chen, et al., which is incorporated herein by reference in it entirety for all purposes. Specific embodiments of the present invention may employ the C-INSight™ product to provide data models optimized for use with visualization applications, including OLAP and the like, in order to enable users to analyze information. Specific embodiments provide Reverse Star Schema meta models in which spatial-centric applications can be readily deployed. However, the present invention provides for a variety of embodiments in addition to the C-INSight™ product.

The information aggregator 102 aggregates the data based upon regions or locations 105 within the n-dimensional presentation area 104. In a specific embodiment, the presentation area 104 can be a 2-dimensional depiction of a map, having one or more layers of information presented thereon in order to provide a multidimensional presentation of one or more types of information. The information aggregator 102 may be implemented in hardware, software or combinations thereof. In one specific embodiment, the information aggregator comprises a computer program product operable on a general purpose computer system. The functions and features of the information aggregator 102 will be described herein below in greater detail.

FIG. 1B illustrates another representative spatial analysis system in a specific embodiment of the present invention. In FIG. 1B, a spatial-object meta data repository 106 is operatively disposed to receive information about regions 105 defined in the n-dimensional presentation 104 and to store the region information as meta data. Further, a region analyzer 103 is interposed between information aggregator 102 and n-dimensional presentation 104. The region analyzer 103 provides further compilation of the aggregated data from the information aggregator 102 based upon the spatial-object meta data stored in spatial-object meta data repository 106.

In a specific embodiment, n-dimensional presentation 104 comprises a map presented in accordance with a geographic information system (GIS). Such “GIS” presentations provide a mechanism for spatial analysis by automating map management functions. In a specific embodiment, a technique known as “Geocoding,” a GIS component, is used to draw points on a digital map presentation, such as n-dimensional presentation 104, for example. Conventionally known geocoding techniques are capable of comparing address of the event to an expected range of addresses along a certain block. As an example, 4107 S. Yale St., Hometown, U.S.A. is the address of Some Fictitious Mall. Numerous shoplifting arrests are recorded for this address. Mapping may be performed by locating a segment of South Yale Avenue that contains an address range of 4101 to 4199 along the east side of the street, and then calculating that a point representing one of the shoplifting incidents should be drawn in the middle of this computed range. Other crimes, perhaps occurring at 4170 S. Yale St., would also be drawn at substantially similar places in the presentation.

In a specific embodiment, crime data can be geocoded for presentation on an n-dimensional presentation 104. When viewed at a distant scale, geocoded data can show relative location and density of events. When zoomed in at close range, geocoded crime information provides approximate indications for occurrences of criminal activity. In some embodiments, a symbol may be placed exactly where the crime occurred. In other instances, a symbol can be used to represent an approximate location of a plurality of events.

In specific embodiments, one or more spatial extensions may be added to objects in data warehouse's 101 in order to make use of geographical tools. Data objects may include spatial attributes in the metadata. For example, attributes may be added to centric entities and/or activity entities in the data warehouse 101, whenever you are using C-Insight to import database objects to populate the repository.

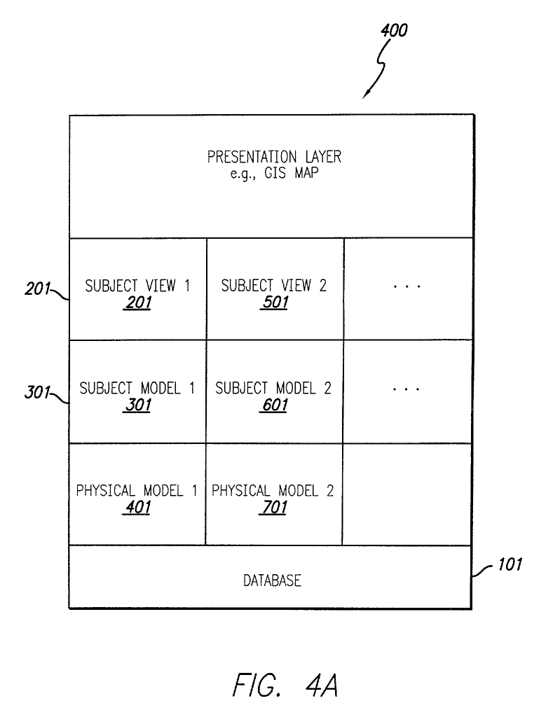

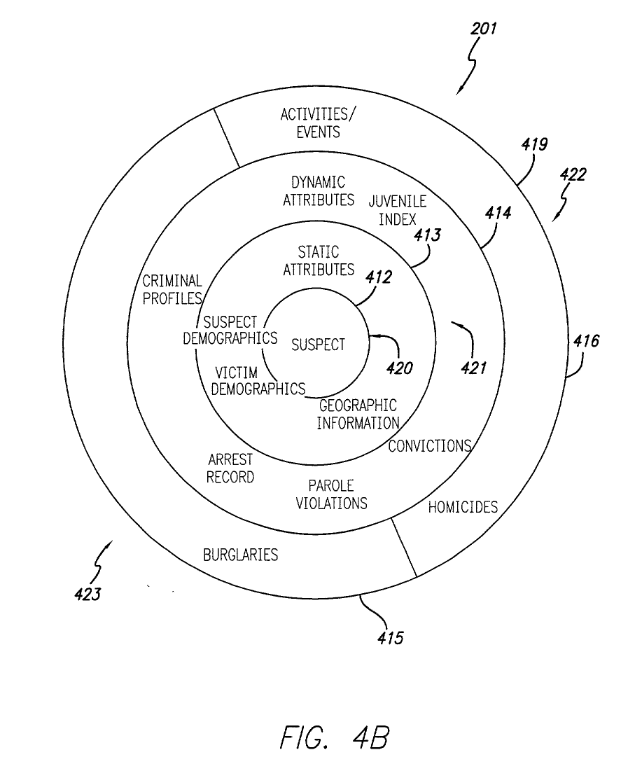

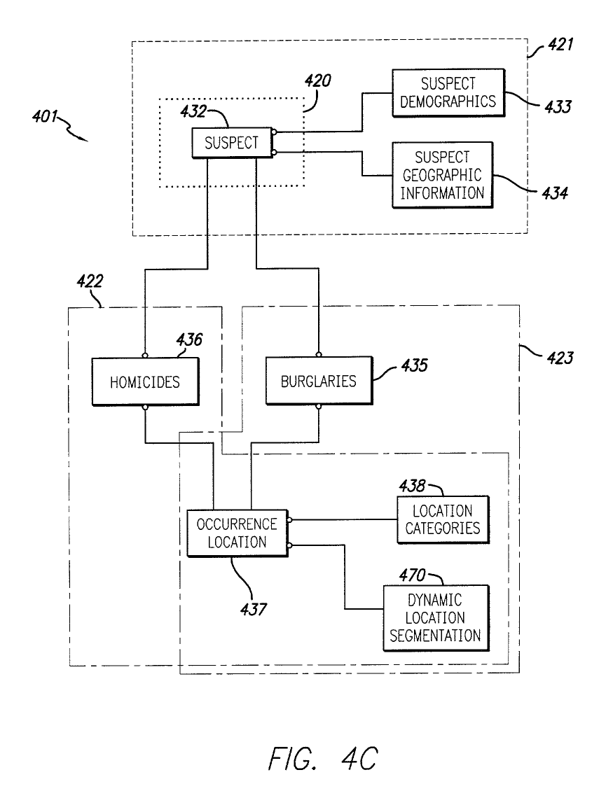

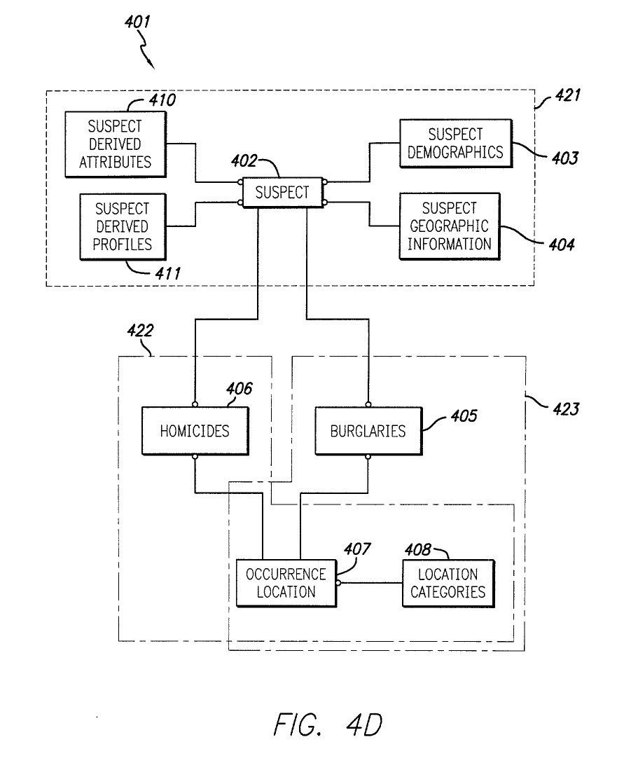

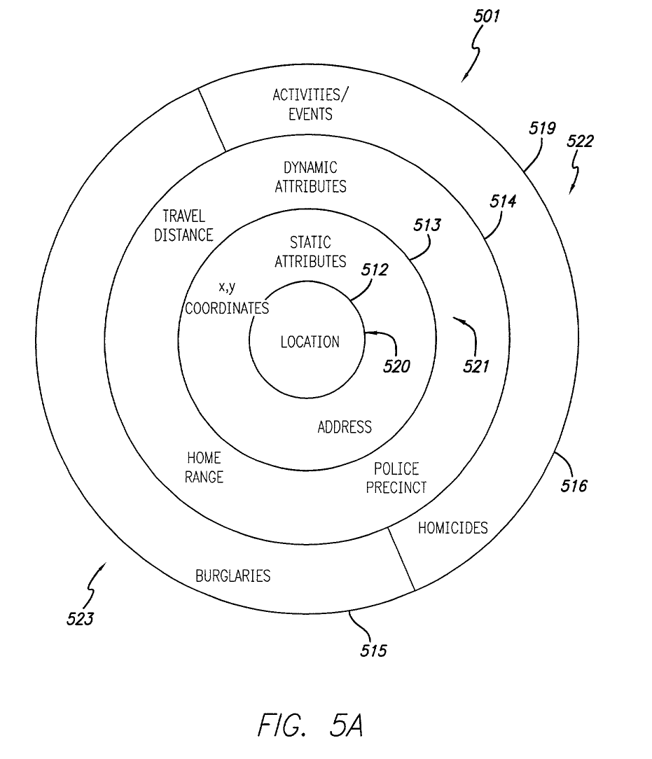

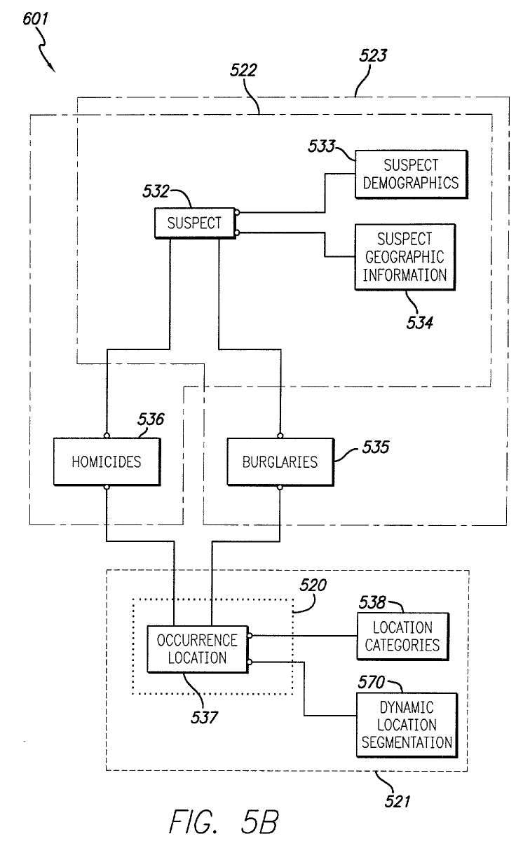

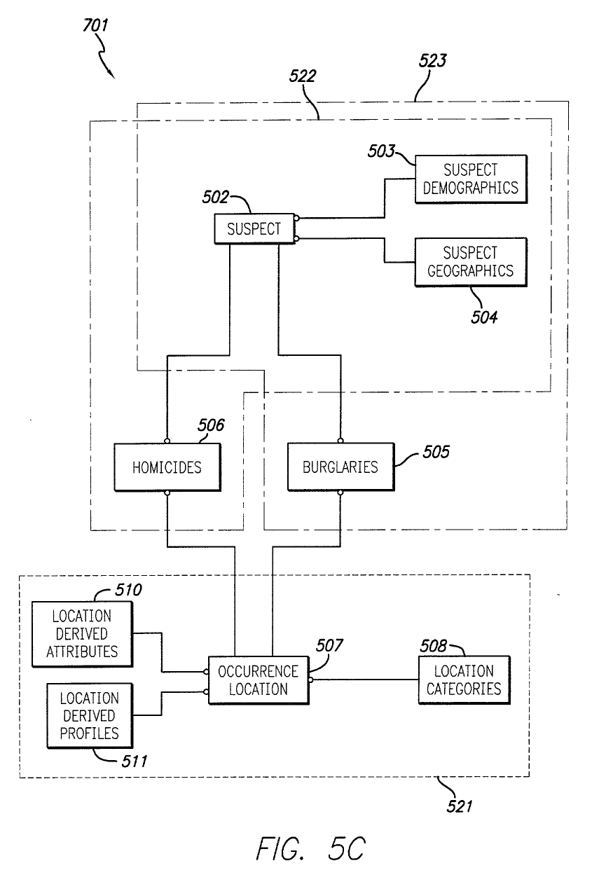

FIG. 1C illustrates a further representative spatial analysis system in a specific embodiment of the present invention. FIG. 1C illustrates a plurality of relationships between the spatial analysis components illustrated by FIG. 1A, such as the data warehouse 101, information aggregator 102, criterion 103, and n-dimensional presentation area 104. As shown by FIG. 1C, data warehouse comprises a plurality of information entities, such as entities 402 and 507, for example, associated with one another by a variety of relationships. Relationships may be one or many, one to one, or many to one, for example. One or more physical schemas, such as physical schema 401 and physical schema 701 describe the relationships between the various entities in the data warehouse 101. Physical schemas 401 and 701 are described with reference to particular specific embodiments of the present invention herein below with reference to FIGS. 4A, 4D, and 5C, for example. Information aggregator 102 comprises one or more virtual schemas 601 and 301, that map various relationships between information entities in the data warehouse 101 of interest to users. Virtual schemas can be defined, redefined, or developed to suit the wants or desires of consumers of intelligence developed from the information within the data warehouse 101. FIG. 1C illustrates a location centric virtual schema 601 and a non-location centric virtual schema 301. Virtual schemas 301 and 601 are described with reference to particular specific embodiments of the present invention herein below with reference to FIGS. 4A, 4C, and 5B, for example. The location centric virtual schema 601 has a focus group 521. Focus group 521 is comprised of a core component 520, having a centric entity 537, location, that represents information about locations. One or more customized groups 522, 523 comprising of information entities (not shown) provide information related to the core component 520. This type of arrangement of information entities is termed a “Reverse Star Schema.” One or more derived attributes 97 may be determined from relationships between non-location information entities and location information entities within the data warehouse 101, of which location entity 93, non-location entity 94 are illustrative. Derived attributes can provide intelligence from information about events, activities, transactions, occurrences, segmentations, profiles, calculations, and the like determined from the information in the data warehouse 101. Derived attributes determined from information having a spatial component, such as location entity 93, for example, may be displayed on n-dimensional presentation 104. One or more layers of intelligence may be depicted on presentation 104, in specific embodiments.

FIG. 1D illustrates a yet further representative spatial analysis system in a specific embodiment of the present invention. In FIG. 1D, a spatial analysis system, such as that of FIG. 1C, is provided in which spatial object meta data in meta data repository 106 can be used to supplement analyses provided by aggregator 102. In FIG. 1D, an input of some information denoting redefined regions 109 on the n-dimensional presentation 104 may be used to redefine spatial components in the virtual schema 601. The information can be stored in the spatial meta data store 106 in some specific embodiments. The region information can be used to redefine segmentation of spatial information with respect to the n-dimensional presentation 104. The region information can be reflected into one or more virtual schemas, such as by an addition of a new dynamic location segmentation entity 570 of virtual schema 601, for example. Accordingly, new intelligence may be dynamically derived based upon the redefined regions 109 on the n-dimensional presentation 104. In specific embodiments, new intelligence may be gained without having to change or alter the underlying information in the data warehouse 101.

FIG. 1E illustrates a still further representative spatial analysis system in a specific embodiment of the present invention. In FIG. 1E, region analyzer 107 provides aggregation of information from the analyzer 102 based upon the spatial-object meta data stored in the spatial meta data repository 106. Region analyzer 107 can provide dynamic updating of the displayed information of presentation 104 without changing virtual schema 601 in the information analyzer 102, for example.

FIG. 1F illustrates a still further representative spatial analysis system in a specific embodiment of the present invention. In FIG. 1F, relationships between a variety of information objects, such as business information objects like customers, prospects, stores, suppliers, cities, counties, bridges, police districts, customer behavioral characteristics, products, merchandise, and the like, can be developed via a topical modeling process. The topical modeling can be implemented in hardware, software, or some combination thereof. Spatial extensions and virtual schemas, such as reverse star schemas (RSS), geo-coding and the like, support analyses tools and techniques such as derived attributes, segmentation, profiling, events, mining and so forth. Spatial analysis tools and techniques such as clustering, home range computations, spider diagrams and the like provide access to spatial segmentation and zoning analyses. FIG. 1F illustrates just a few of a wide variety of analyses that can be used in accordance with the many specific embodiments of the present invention. Thus, FIG. 1F is intended to be illustrative and not limiting.

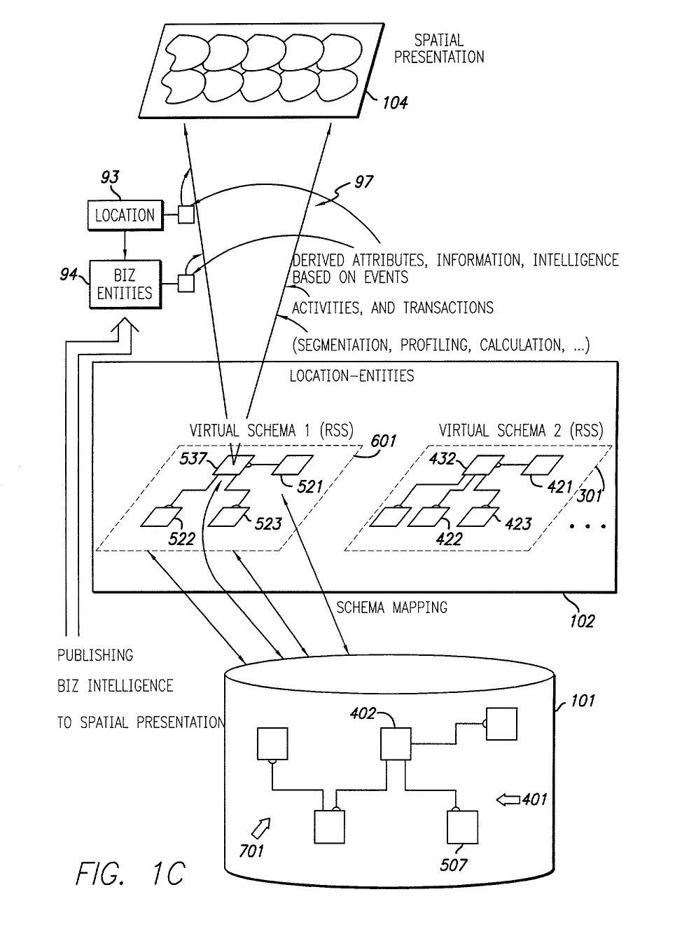

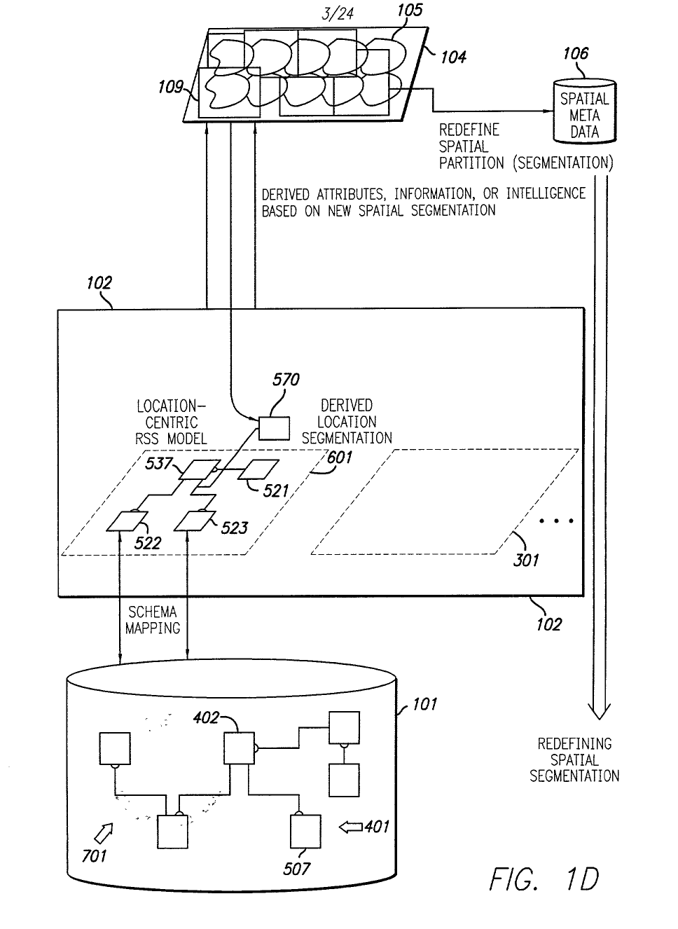

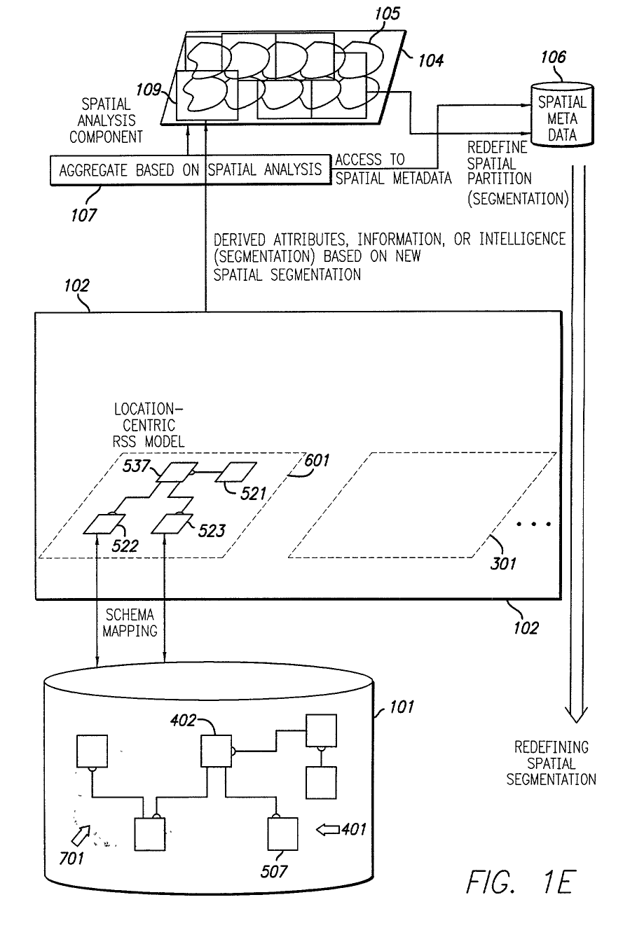

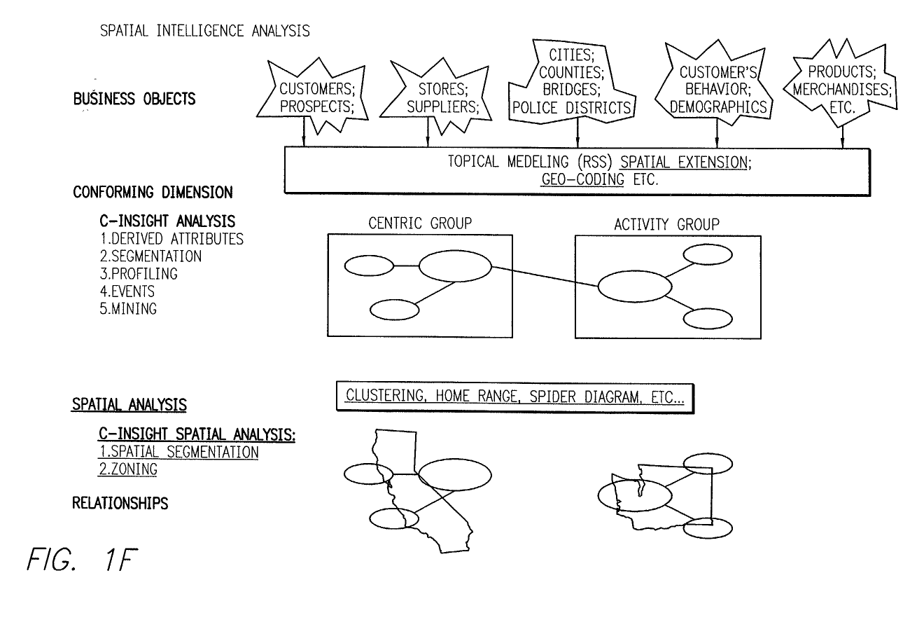

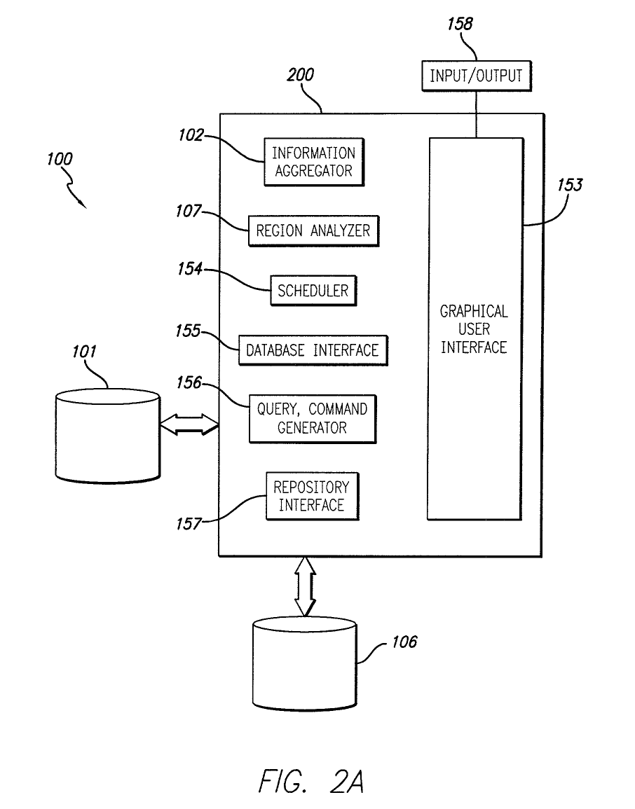

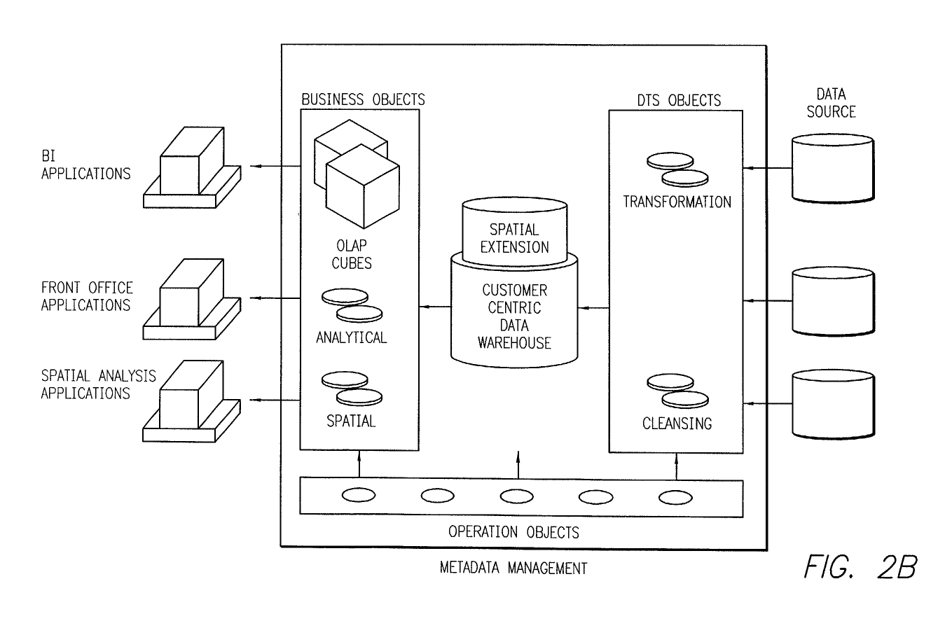

FIG. 2A illustrates a representative architecture of a system suitable for embodying a spatial analysis applications in a specific embodiment of the present invention. As shown in FIG. 2A, in a specific embodiment, a system 100 for managing and analyzing information comprises a computer system 200, coupled to database 101, a metadata repository 106, and an optional input/output device(s) 158, which can be a console, display screen or the like. In specific embodiments, metadata repository 106 may be combined with or co-located with database 101. In some specific embodiments, one or both of metadata repository 106 and database 101 may be located on the computer system 200, while in alternative embodiments, one or both of metadata repository 106 and database 101 may be located on another computer system (not shown), which may be a server computer, for example. In some specific embodiments, a network may connect computer system 200 with a server computer having access to database 101 and/or metadata repository 106, so that a client-server relationship is established. However, a client-server relationship is not necessary to practice the invention.

A plurality of software processes resident on computer system 200 provide various functions to the user. For example, a database interface software process 155 maintains the information in the database 101. A query/command generator software process 156 provides access to the information in the database 101. A scheduler software process 154 coordinates the events and actions in the computer system 200. A repository interface software process 157 provides an interface to metadata repository 106. Information aggregator 102 groups information for presentation on an n-dimensional presentation mechanism 104 via input and output 158, for example. Region analyzer 107 provides region information to the information output by the information aggregator 102. A graphical user interface software process 153 enables users to create and view logical models, subject models and physical models, and the like.

In specific embodiments, users can create applications such as n-dimensional presentation 104 of FIG. 1A, reports, perform data mining, enter, edit and apply rules, compute statistics, and so forth by accessing the applications and facilities of computer system 200 using the graphical user interface 153. Graphical User Interface (GUI) 153 can provide enhanced interaction with computer systems providing geographic information of interest to users. Representative screens depicting information presented on an n-dimensional presentation in a GUI of a particular specific embodiment are included herein and described herein below.

FIG. 2B illustrates a representative architecture of another example system suitable for embodying a spatial analysis applications in a specific embodiment of the present invention. In one configuration, spatial data may be populated in metadata repository 106, as illustrated by a spatial extension in FIG. 2B. For example, the following metadata can be added to each table object in the repository: (1) a spatial entity flag; and (2) a spatial data type, which may be provided for each column in table objects in the metadata repository 106. Business objects can also receive spatial extension information. For example the following business objects can have a spatial component: (1) Aggregation; (2) Segmentation/Profiling; (3) Key Performance Index; and (4) Future objects.

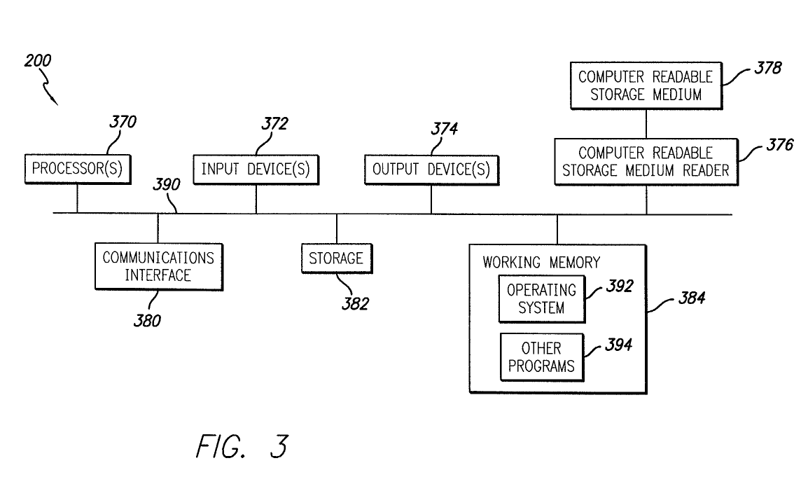

FIG. 3 illustrates a block diagram of a representative computer system in a specific embodiment of the present invention. As illustrated by FIG. 3, a computing system 200 can embody one or more of the elements illustrated by FIG. 2 in various specific embodiments of the present invention. While other application-specific alternatives might be utilized, it will be presumed for clarity sake that the elements comprising the computer system 200 are implemented in hardware, software or some combination thereof by one or more processing systems consistent therewith, unless otherwise indicated.

Computer system 200 comprises elements coupled via communication channels (e.g. bus 390) including one or more general or special purpose processors 370, such as a Pentium® or Power PC®, digital signal processor (“DSP”), and the like. System 200 elements also include one or more input devices 372 (such as a mouse, keyboard, microphone, pen, and the like), and one or more output devices 374, such as a suitable display, speakers, actuators, and the like, in accordance with a particular application.

System 200 also includes a computer readable storage media reader 376 coupled to a computer readable storage medium 378, such as a storage/memory device or hard or removable storage/memory media; such devices or media are further indicated separately as storage device 380 and memory 382, which can include hard disk variants, floppy/compact disk variants, digital versatile disk (“DVD”) variants, smart cards, read only memory, random access memory, cache memory, and the like, in accordance with a particular application. One or more suitable communication devices 384 can also be included, such as a modem, DSL, infrared or other suitable transceiver, and the like for providing inter-device communication directly or via one or more suitable private or public networks that can include but are not limited to those already discussed.

Working memory further includes operating system (“OS”) elements and other programs, such as application programs, mobile code, data, and the like for implementing system 200 elements that might be stored or loaded therein during use. The particular OS can vary in accordance with a particular device, features or other aspects in accordance with a particular application (e.g. Windows, Mac, Linux, Unix or Palm OS variants, a proprietary OS, and the like). Various programming languages or other tools can also be utilized, such as known by those skilled in the art. As will be discussed, embodiments can also include a network client such as a browser or email client, e.g. as produced by Netscape, Microsoft or others, a mobile code executor such as a Java Virtual Machine (“JVM”), and an application program interface (“API”), such as a Microsoft Windows compatible API. (Embodiments might also be implemented in conjunction with a resident application or combination of mobile code and resident application components.)

One or more system 200 elements can also be implemented in hardware, software or a suitable combination. When implemented in software (e.g. as an application program, object, downloadable, servlet, and the like in whole or part), a system 200 element can be communicated transitionally or more persistently from local or remote storage to memory (or cache memory, and the like) for execution, or another suitable mechanism can be utilized, and elements can be implemented in compiled or interpretive form. Input, intermediate or resulting data or functional elements can further reside more transitionally or more persistently in a storage media, cache or more persistent volatile or non-volatile memory, (e.g. storage device 380 or memory 382) in accordance with a particular application.

FIG. 4A illustrates a representative application information architecture capable of supporting a decision support application in a specific embodiment of the present invention. As shown by FIG. 4A, an architecture diagram 400 comprises of database 101 that contains information about a business process in a specific embodiment. The database 101 contains a plurality of data elements. The data contained within database 101 may be organized in a variety of different ways, which may be called schema. In a specific embodiment, database 101 is a relational database. A physical model 401 conceptualizes relationships between various data elements within database 101. Physical models, such as, for example relational models, provide one or more relationships between information elements, such as a suspect, a crime scene, or a customer, a transaction, a product, and so forth, stored in the relational database 101. Representative examples of physical models will be described herein with reference to specific embodiments of FIG. 4D. Physical model 401 is representative of relationships between and among information within the data warehouse 101. One or more virtual schemas, or subject models, such as subject model 301 may be formulated to represent the concepts underlying the physical model 401. Subject model 301 comprises a reverse star schema (RSS) relationship among a plurality of data elements stored in the database 101. Other types of virtual schema may be used in various specific embodiments. Subject model 301 provides a way for users and consumers of the data in database 101 to think about the relationships among the data in a useful way. Representative examples of subject models will be described herein with reference to specific embodiments of FIG. 4C.

One or more logical models, such as logical model 201, provide a subject view of the relationships described by the subject model 301. Logical model 201 centers about a single subject, such as a suspect, a location, a customer, or a product, for example, that is the focus of one or more analyses. Logical model 201 provides a way for users and consumers of the data in database 101 to view relationships between different data elements in the database 101 in a hierarchical way. Representative examples of logical models will be described herein with reference to specific embodiments of FIG. 4B.

The logical models support applications at a presentation layer 405. Presentation layer 405 includes one or more applications, such as MapPoint™, a product of Microsoft Corporation, and so forth, that may be used in various specific embodiments of the present invention. The specific embodiment having a software architecture shown in FIG. 4A can support a multiple subject system, in which different applications run using the data stored in the database 101. Accordingly, more than one subject model and more than one subject view may be included in some specific embodiments of the present invention.

FIG. 4B illustrates a representative logical model in a specific embodiment of the present invention. In FIG. 4B, a logical model 201 for a single subject system in a specific embodiment is shown. Logical model 201 comprises a single centric subject, such as suspect, which is the center concept 412 of logical model 201. In various specific embodiments, the centric subject could be customers, products, sales, line of business, persons, property or the like. Surrounding the center concept 412 are one or more static attributes 413, such as demographics of a victim, demographics of a suspect, or geographic information about a suspect. Further, one or more dynamic attributes 414 may be derived from the static attributes and activities/events 419. For example, one or more criminal profiles may be derived from information about the suspect. Further, one or more activities and events 419 may be defined for the center concept 412. For example, a homicide and a burglary are activities/events relating to the center point suspect. Accordingly, in FIG. 4B, the suspect is the center concept 412, while geographic information and suspect demographics are static attributes 413. These are merely representative examples of the many possible static attributes that may be used in various specific embodiments of the present invention. Burglary crimes 415 and homicide crimes 416 are examples of activities/events 419. Surrounding the static attributes 413 are one or more dynamic attributes 414, which may be derived from the static attributes 413 and/or from one or more activities and events 419. For example, a juvenile index, a dynamic attribute, may be determined from demographic information about the suspect, a static attribute 413. One or more activities and events 419 may be defined for the center concept 412.

Dynamic attributes 414 can also be derived from activities/events 419. For example, a criminal profile can be derived from the homicide crimes 416 information belonging to the activities/events 419. Accordingly, a user may derive various dynamic attributes and profiles about the center concept 412 of the logical model 201, such as a juvenile index, a list of parole violations, a list of convictions, and so forth. Dynamic attributes 414, static attributes 413 and center concept 412 comprise a focal group 421. Activities/events 419 may be divided into customized groups. A core component 420 comprises center concept 412. A first customized group 423 comprises information entities in burglary crimes 415, as well as lookup information related to residences involved in the burglary incidents (not shown). A second customized group 422 comprises homicide crimes 416, as well as lookup information related to residences involved in the homicide incidents (not shown).

FIG. 4C illustrates a derived subject model in a specific embodiment of the present invention. In FIG. 4C, a derived subject model 301 corresponding to the logical subject model 201 of FIG. 4B in a specific embodiment is shown. Derived subject model 301 comprises a plurality of relationships between a plurality of groups and information entities in database 101, as illustrated by logical model 201. Logical model 201 provides a suspect centric view, with the core component 420 comprising center concept 412, the suspect. Accordingly, the derived subject model 301 comprises a suspect entity 432. Static attributes are represented by a suspect demographics entity 433, which comprises demographics information for each suspect in suspect entity 432, and a suspect geographic entity 434, which comprises geographical information about each suspect in suspect entity 432. A homicides entity 436 comprises homicide incident data, such as a time, a date, a weapon, a description, and so forth, for a plurality of homicide incidents involving suspects in suspect entity 432. A burglary incidents entity 435 comprises burglary data, such as a time, a date, and an item(s), and so forth, for a plurality of burglary incidents involving suspects in the suspect entity 432.

An occurrence location entity 437 comprises information that describes the location of the occurrence and its characteristics, such as an address, a description, a ward, and so forth. A police precinct entity 438 comprises classification information for classifying location entity 437 into police precincts. In a specific embodiment, the entities comprising the derived subject model 301 have a reverse star schema arrangement, with the suspect entity 432 comprising a core component 420, as indicated by a dotted line in FIG. 4C. Suspect entity 432, suspect demographics entity 433 and suspect geographic entity 434 comprise a focal group 421. A first customized group 422 comprising of homicides entity 436, occurrence location entity 437 and police precinct categories entity 438 provides information related to the core component 420, which includes suspect entity 432. A second customized group 423 comprising of burglaries entity 435, occurrence location entity 437 and location categories entity 438 provides another set of information related to the core component 420 and the suspect entity 432. As a result of redefining regions on presentation 104, as discussed herein above with reference to FIG. 1C, a dynamic location entity 470 is created in focal group 421. The dynamic location entity 470 represents new intelligence available by redefining regions 109 in presentation 104. One or more attributes may be dynamically created from entity 470 to provide the new intelligence in a specific embodiment. Accordingly, the remainder of the information entities in the derived subject model 301 is arranged according to their relationships with the core component 420. A variety of other arrangements and relationships among the entities in the derived subject model 301 may also be used in various specific embodiments according to the present invention.

FIG. 4D illustrates a physical model in a specific embodiment of the present invention. In FIG. 4D, a physical model 401 corresponding to the derived subject model 301 of FIG. 4C in a specific embodiment is shown. Physical model 401 is a relational model that illustrates relationships between entities of suspect, incident, and location that are incorporated in information stored in the database 101. In a specific embodiment, the database is a relational database, however, other methods of storing and retrieving information may be used in various other specific embodiments as will be evident to those skilled in the art. In physical model 401, a plurality of dynamic attributes and profiles has been derived from the derived subject model 301. A star schema organization of the data entities in the focus group 421 is created dynamically by a software process based upon the virtual schema meta model underlying arrangement of information entities in FIG. 4C in a specific embodiment. In a specific embodiment, C-INSight™, a product of MetaEdge Corporation, of Sunnyvale, Calif., provides the capability to dynamically derive attributes and profiles from static data based upon a virtual schema, such as a reverse star schema, for example, and to create a star schema, and, hence a multidimensional cube, dynamically.

The physical model 401 comprises a suspect entity 402 that is central to the focus group 421. Static attributes are represented by a suspect demographics entity 403, which comprises demographics information for each suspect in suspect entity 402, and a suspect geographic entity 404, which comprises geographical information about each suspect in suspect entity 402. One or more dynamically derived attributes may also comprise focus group 421. For example, in a specific embodiment illustrated by FIG. 4D, suspect derived attributes 410 and suspect derived profiles 411 include derived information about suspects in suspect entity 402.

A first customized group 422 comprises a homicides entity 406, which comprises homicide incidents data, such as a time, a date, and a weapon, and so forth, for a plurality of homicide incidents involving suspects in suspect entity 402. Further, customized group 422 comprises an occurrence location entity 407, which comprises information that describes the location of the occurrence and its characteristics, such as an address, district name, a ward, and so forth, and a location categories entity 408, which comprises location classification information useful to classify locations according to police precincts, wards, and the like, for example.

A second customized group 423 comprises a burglary incident entity 405, which comprises burglary incident data, such as a time, a date, an amount, an item description, and so forth, for a plurality of burglary incidents involving suspects in suspect entity 402. Customized group 423 further comprises occurrence location entity 407, and location categories entity 408.

FIG. 5A illustrates a representative logical model in a specific embodiment of the present invention. In FIG. 5A, a logical model 501 for a single subject system in a specific embodiment is shown. Logical model 501 comprises a single subject: location, which is the center concept 512 of logical model 501. Surrounding the center concept 502 are one or more static attributes 513. Static attributes 513, such as location descriptors, for example, comprise information relating to the subject at the center concept 512, location, in the specific embodiment in FIG. 5A. Here, defining a location in terms of x, y coordinates is one example of a static attribute 513. This is merely a representative example of the many possible static attributes that may be used in various specific embodiments of the present invention. Surrounding the static attributes 513 are one or more dynamic attributes 514, which may be derived from the static attributes 513 and/or from one or more activities and events 519. One or more activities and events 519 may be defined for the center concept 512. For example, homicide incidents and burglary incidents are representative activities/events for location center concept 512. Other categories may be added to activities/events 519 in various specific embodiments. A dynamic attribute, such as a number of incidents per category, for example, may be derived from incident category information about the location, which is a static attribute 513. Dynamic attributes 514 can also be derived from activities/events 519. For example, a monthly average incident occurrence per location can be derived from the homicide incidents information belonging to the activities/events 519. Accordingly, a user may derive various dynamic attributes and profiles about the center concept 512 of the logical model 501. In another example, dynamic attributes such as an average monthly sales, a product turn around time, a product popularity (purchase-return) level, and so forth, may be derived in specific embodiments of the present invention useful in business applications.

Center concept 512 comprises a core component 520. Dynamic attributes 514, static attributes 513 and center concept 512 comprise a focal group 521. Activities/events 519 are divided into customized groups. A first customized group 522 comprises information entities in homicide incidents 516, as well as lookup information related to suspects involved in the incidents (not shown). A second customized group 523 comprises burglary incidents 515, as well as lookup information related to suspects involved in the incidents (not shown).

FIG. 5B illustrates a derived subject model in a specific embodiment of the present invention. In FIG. 5B, a derived subject model 601 corresponding to the logical subject model 501 of FIG. 5A in a specific embodiment is shown. Derived subject model 601 comprises a plurality of relationships between a plurality of groups and information entities in database 101, and illustrated by logical model 501, which provides a location centric view. The derived subject model 601 comprises a central concept 537 of a location. A location categories entity 538 comprises categorization and other information about the location entity 537. Useful categories for locations can include police precincts, wards, counties, and the like, for example. Location entity 537 comprises a core component 520, which is indicated by a dotted line in FIG. 5B. Further, location entity 537 and location categories entity 538 comprise a focal group 521, indicated by a dashed line in FIG. 5B. As a result of redefining regions on presentation 104, as discussed herein above with reference to FIG. 1C, a dynamic location entity 570 is created in focal group 521. The dynamic location entity 570 represents new intelligence available by redefining regions 109 in presentation 104. One or more attributes may be dynamically created from entity 570 to provide the new intelligence in a specific embodiment. Accordingly, the remainder of the information entities in the derived subject model 601 is arranged according to their relationships with the core component 520. A variety of other arrangements and relationships among the entities in the derived subject model 601 may also be used in various specific embodiments according to the present invention.

A homicide incident entity 536 comprises homicide incident data, such as a time, a date, a weapon, a description, and so forth, for a plurality of homicide incidents at locations in location entity 537. A burglary incident entity 535 comprises burglary incident data, such as a time, a date, an item, and so forth, for a plurality of burglary incidents for locations in location entity 537.

A suspect entity 532 comprises information that describes each individual suspect of incidents in either the homicide incident entity 536 or the burglary incident entity 535. A suspect demographics entity 533 comprises demographics information for each suspect in suspect entity 532. A suspect geographic entity 534 comprises geographical information about each suspect in suspect entity 532. In a specific embodiment, the entities comprising the derived subject model 601 have a reverse star schema arrangement, with the location entity 537 comprising a core component 520, as indicted by a dotted line in FIG. 5B. Location entity 537 and location categories entity 538 comprise a focal group 521.

A first customized group 522 comprising homicide incidents entity 536, suspect entity 532, suspect demographics entity 533, and suspect geographic information entity 534 provides information related to the core component 520, which comprises location entity 537. A second customized group 523 comprising burglary incidents entity 535, suspect entity 532, suspect demographics entity 533, and suspect geographic information entity 534 provides another set of information related to the core component 520, which comprises the location entity 537. Accordingly, the remainder of the information entities in the derived subject model 601 are arranged according to their relationships with the core component 520. A variety of other arrangements and relationships among the entities in the derived subject model 601 may also be used in various specific embodiments according to the present invention.

FIG. 5C illustrates a physical model in a specific embodiment of the present invention. In FIG. 5C, a physical model 701 corresponding to the derived subject model 601 of FIG. 5B in a specific embodiment is shown. Physical model 701 is a relational model that illustrates relationships between entities of suspect, incidents, and locations that are incorporated in information stored in the database 101. In a specific embodiment, the database is a relational database, however, other methods of storing and retrieving information may be used in various other specific embodiments as will be evident to those skilled in the art. In physical model 701, a plurality of dynamic attributes and profiles have been derived from the derived subject model 601 in FIG. 5B. A star schema organization of the data entities in the focus group 521 is created dynamically by a software process in a specific embodiment. In a specific embodiment, C-INSight™, a product of MetaEdge Corporation, of Sunnyvale, Calif., provides the capability to dynamically derive attributes and profiles from static data.

The physical model 701 comprises a location entity 507 that is central to the focus group 521. Location entity 507 comprises location information that describes the location and its characteristics, such as a district name, an address, and so forth. Static attributes are represented by a location categories entity 508, which comprises location classification information useful in aggregating locations into groupings or regions, for example. In FIG. 5C, locations may be classified according to police precincts, wards, counties, states, and the like, for example. One or more dynamically derived attributes may also comprise focus group 521. For example, in a specific embodiment illustrated by FIG. 5C, a location derived attributes 510 and a location derived profiles 511 include derived information about customers in customer entity 507.

A first customized group 522 comprises a homicide incidents entity 506, which comprises homicide incident data, such as a time, a date, a weapon, a description, and so forth, for a plurality of homicide incidents involving suspects in suspect entity 502. Further, customized group 522 comprises a suspect entity 502, a suspect demographics entity 503, which comprises demographics information for each suspect in suspect entity 502, and a suspect geographic entity 504, which comprises geographical information about each suspect in suspect entity 502.

A second customized group 523 comprises a burglary incident entity 505, which comprises burglary incident data, such as a time, a date, an item, and so forth, for a plurality of burglary incidents. Customized group 523 further comprises suspect entity 502, suspect demographics entity 503, which comprises demographics information for each suspect in suspect entity 502, and suspect geographic entity 504, which comprises geographical information about each suspect in suspect entity 502.

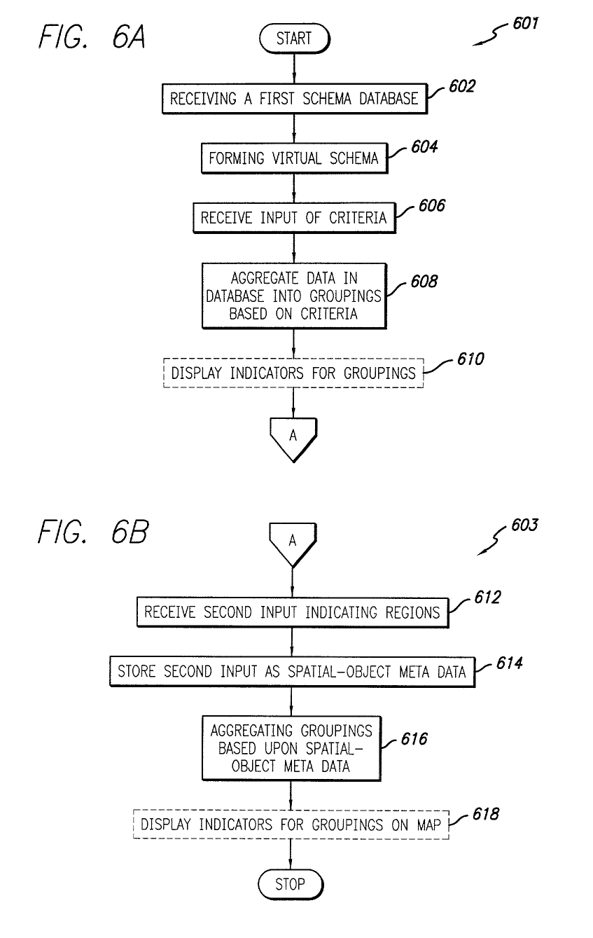

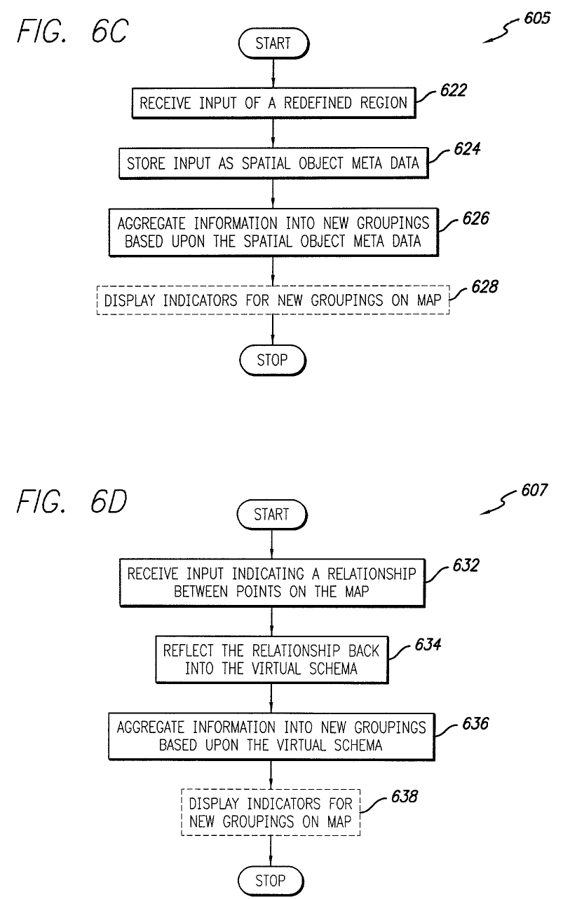

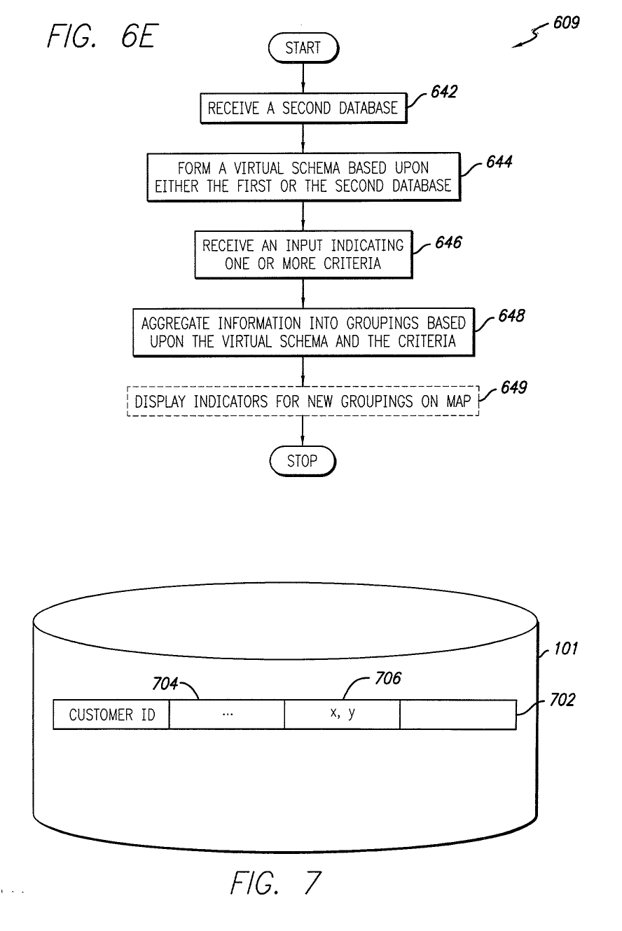

FIG. 6A illustrates a flowchart of a representative process for managing information with spatial components in a specific embodiment of the present invention. As illustrated in flowchart 601 of FIG. 6A, the process includes receiving a first schema database 602. Then, a virtual schema is formed 604. The virtual schema includes at least a portion of a dataset included within the first database. A first input indicating a criterion is received 606. Then, data of the database is aggregated into one or more groupings in accordance with the virtual schema and the first input indicating the criteria 608. One or more indicators associated with the one or more groupings may be displayed on an n-dimensional presentation 610.

FIG. 6B illustrates a flowchart of a representative process for managing information with spatial components in a specific embodiment of the present invention. As illustrated in flowchart 603 of FIG. 6B, the process includes receiving a second input indicating one or more regions 612. The second input can be stored as a spatial-object meta data 614. Groupings can be aggregated based upon the spatial-object meta data 616. One or more indicators associated with the one or more groupings may be displayed in a region associated therewith on an n-dimensional presentation 618.

The regions can comprise any of a polygon, a circle, a rectangle, an ellipse, and an animal home range, for example. In one embodiment, one or more regions may be defined as an animal home range, an area in which it is statistically most likely to find a predatory animal. An animal home range can be computed using a technique described in further detail in “Coordinates of a Killer,” Geospatial Solutions, (http://www.geospatial-online.com/1101/1101spokane.html, last accessed Nov. 8, 2001), which is incorporated herein by reference in its entirety.

The second input indicating one or more regions can comprise any of an input from a user, a pre-determined area, a derivation based upon one or more objects on the n-dimensional presentation, and a result of a computation. The pre-determined area can comprise any of a zip code, an area code, a census tract, a Metropolitan Statistical Area (MSA), a nation state, a state, a county, a municipality, latitude, and a longitude. The derivation based upon one or more objects on the n-dimensional presentation can be a region within a specified distance of a power line, for example. The result of a computation can comprise computing an animal home range, the home range providing a region defined by activities of a target; defining within the region a first ellipse; and defining within the region a second ellipse approximately orthogonal to the first ellipse so that an area defined by intersection of the first ellipse and the second ellipse provides a greatest probability of finding the target.

FIG. 6C illustrates a flowchart of a representative process for managing information with spatial components in a specific embodiment of the present invention. As illustrated in flowchart 605 of FIG. 6C, the process can provide redefining the virtual schema based upon the spatial-object meta data. Accordingly, an input indicating one or more redefined regions is received 622. The input is stored as redefined spatial-object meta data 624. Then, the information can be aggregated into new groupings based upon the spatial-object meta data 626. Further, one or more indicators associated with the one or more new groupings can be displayed on an n-dimensional presentation 628.

FIG. 6D illustrates a flowchart of a representative process for managing information with spatial components in a specific embodiment of the present invention. As illustrated in flowchart 607 of FIG. 6D, the process can provide receiving a third input indicating a relationship between a first data point and a second data point on the n-dimensional presentation 632. The relationship can be reflected in the virtual schema 634. Data may be aggregated into one or more new groupings in accordance with the virtual schema 636. Further, one or more indicators associated with the one or more new groupings can be displayed on an n-dimensional presentation 638.

FIG. 6E illustrates a flowchart of a representative process for managing information with spatial components in a specific embodiment of the present invention. As illustrated in flowchart 609 of FIG. 6E, the process can provide receiving a second database 642. A virtual schema including at least a portion of a dataset included within the first database and the second database can be formed 644. A first input indicating a criterion is received 646. The data of the first database and/or the second database may be aggregated into one or more groupings in accordance with the virtual schema and the first input indicating the criterion 648. Further, one or more indicators associated with the one or more new groupings can be displayed on an n-dimensional presentation 649.

FIG. 7 illustrates a conceptual diagram of a representative database in a specific embodiment of the present invention. The database 101 in FIG. 7 includes a data object 702. Data object 702 includes an ID field 704, one or more data fields 706, and a spatial data field 708. Of course, FIG. 7 is merely illustrative of the many different ways to represent information having spatial components in databases and data structures for use with a computer system.

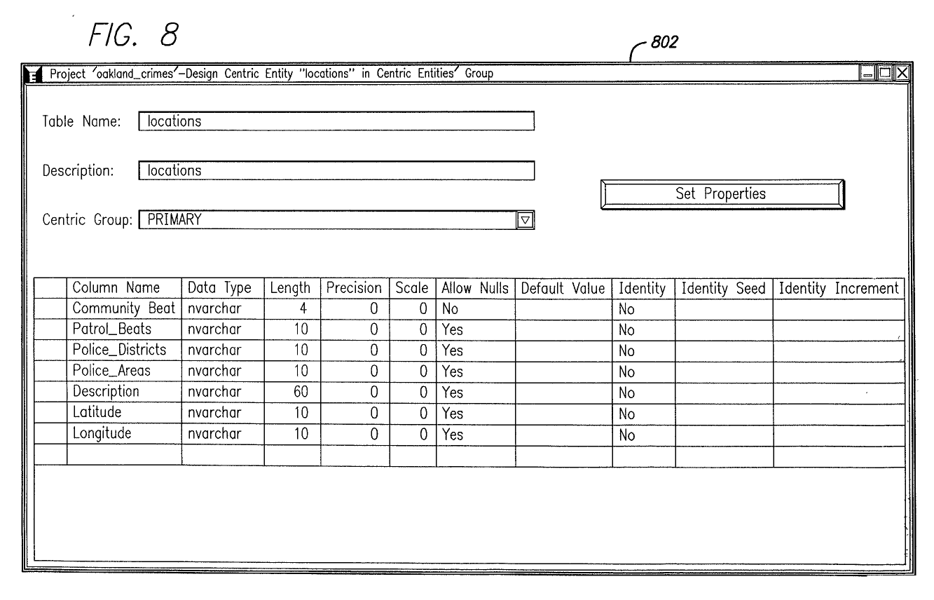

FIG. 8 illustrates a conceptual diagram of a representative user interface screen in a specific embodiment of the present invention. A screen 802 in FIG. 8 comprises a plurality of fields for receiving information about data base tables, spatial and other information components and the like. For example, columns such as community beat, patrol beats, police districts, police areas, description, latitude and longitude are provided for display by the screen 802. Of course, FIG. 8 is merely illustrative of the many ways to represent information in a database or data structure to a user.

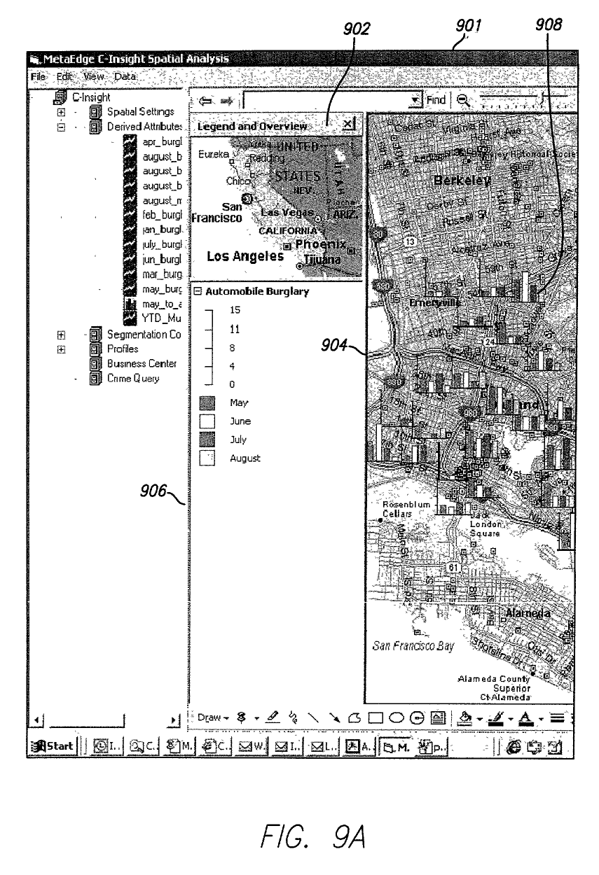

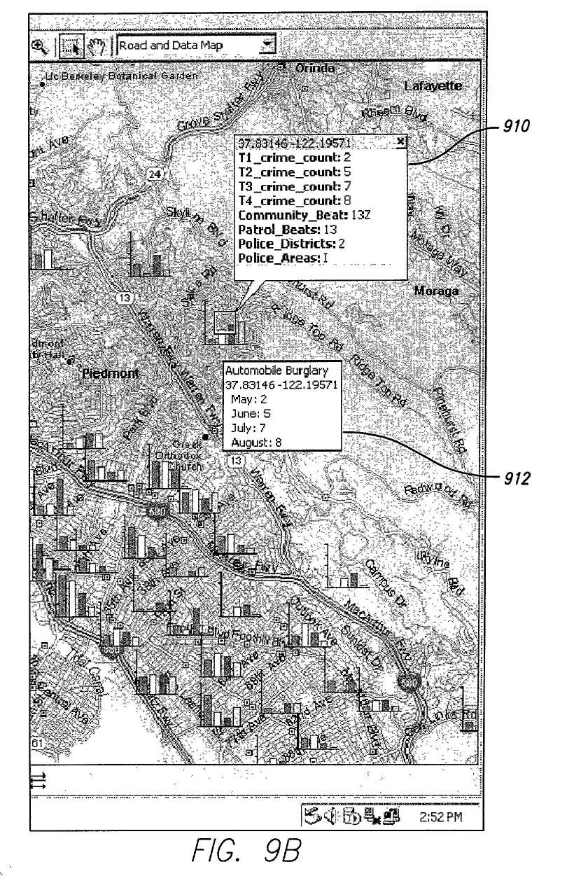

FIGS. 9A-9B illustrate representative example map presentation in a specific embodiment of the present invention. As FIG. 9A shows, a plurality of windows comprise presentation 901. A legend and overview window 902 provides overview information of a mapped area 904 and a legend 906. The mapped area 904 is illustrated by FIG. 9B, as well. Projected onto mapped area 904 is a plurality of indicators, such as indicator 908. These indicators indicate a number of incidents of automobile burglary in a particular location on mapped area 904. In the representative example shown in FIGS. 9A and 9B, the indicators provide information for auto burglaries broken down by month. Many other presentations are provided by various specific embodiments of the present invention, as is readily apparent to those skilled in the art.

FIG. 9B illustrates a continuation of the mapped area 904 illustrated in FIG. 9A. Further, a detail window 910 has been opened for a particular indicator, as shown in FIG. 9B. The detail window 910 provides information about the information underlying the indicator 908. In the representative example illustrated in FIG. 9A, detail window 910 provides an x, y coordinate for indicator 908, and a number of each of various types of crimes occurring within a region associated with the indicator 908. Further, an auxiliary detail window 912 can also be opened up to provide further information about the indicator 908. Auxiliary detail window 912 provides an x, y coordinate for indicator 908, and a number of automobile burglaries occurring in a region represented by the indicator 908 for the months of May, June, July, and August.

Spatial Analysis Applications

The present invention will now be discussed using examples of specific embodiments in illustrative applications. These applications and embodiments are merely illustrative of the many and varied embodiments of the present invention, and are not intended to be limiting.

Law Enforcement—Crime Mapping

Crimes are human phenomena that are non-randomly distributed across the landscape. For crimes to occur, offenders and their targets—the victims and/or property must, for a period of time, exist at the same location. Several factors, from the lure of potential targets to simple geographic convenience for an offender, influence where people choose to break the law. Therefore, an understanding of where and why crimes occur can improve attempts to fight crime. Maps offer crime analysts graphic representations of such crime-related issues.

Mapping crime can help law enforcement protect citizens more effectively in the areas they serve. Simple maps that display the locations where crimes or concentrations of crimes have occurred can be used to help direct patrols to places they are most needed. Policy makers in police departments might use more complex maps to observe trends in criminal activity, and maps may prove invaluable in solving criminal cases. For example, detectives may use maps to better understand the hunting patterns of serial criminals and to hypothesize where these offenders might live.

Using maps that help people visualize the geographic aspects of crime, however, is not limited to law enforcement. Mapping can provide specific information on crime and criminal behavior to politicians, the press, and the general public.

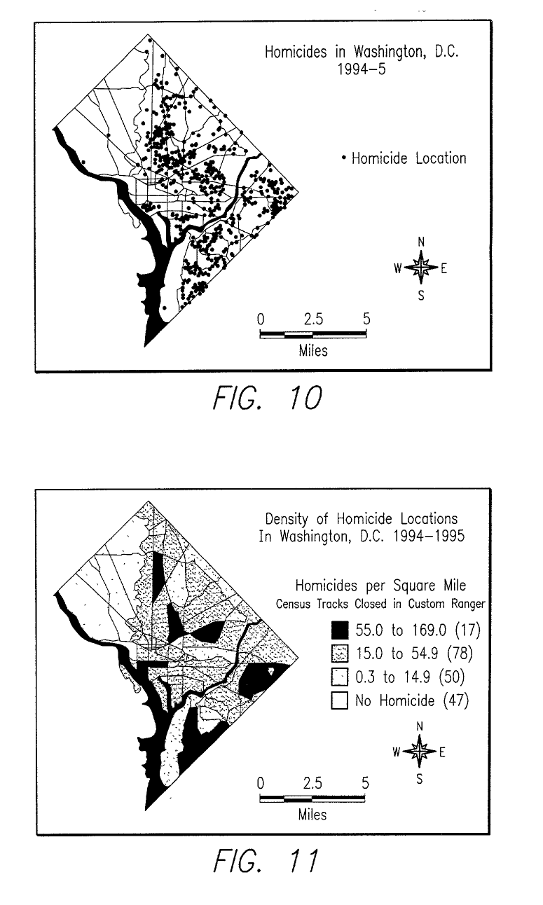

FIG. 10 illustrates a mapping of crime locations in a specific embodiment of the present invention. Some maps useful to those persons who patrol and investigate crimes simply indicate where incidents have occurred. Prior to recent technological advances, police typically placed pushpins in wall maps to examine the spatial distribution of crime locations. More modem approaches permit police to produce more versatile electronic maps by combining their databases of reported crime locations with digitized maps of the areas they serve. As shown in the example of FIG. 10 a plurality of homicide crimes can be plotted by location in a particular geographic area.

FIG. 11 illustrates a mapping of a crime density in a specific embodiment of the present invention. Crime density values, such as the number of crimes per square mile, can be calculated, and the result plotted on a map. FIG. 11 illustrates an example in which crime density for homicide crimes is plotted for a particular geographic area.

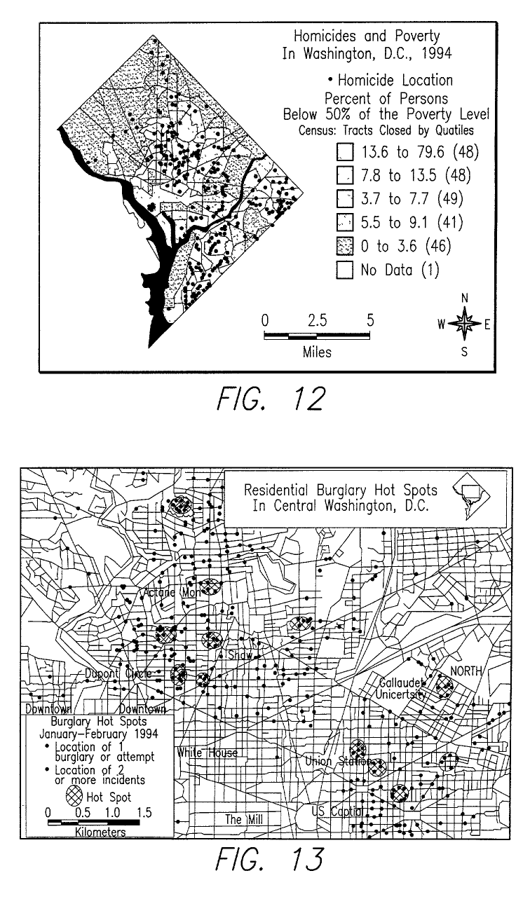

FIG. 12 illustrates a mapping of a combination of data from a plurality of sources in a specific embodiment of the present invention. Spatial data from sources other than law enforcement can be very relevant in crime analysis. The map illustrated by FIG. 12 shows combined data from a Police Department and data from the U.S. Census, which may be useful in examining the location of homicides with respect to demographic factors, for example. In the example illustrated by FIG. 12, homicide crimes and poverty information are combined and plotted on a single map.

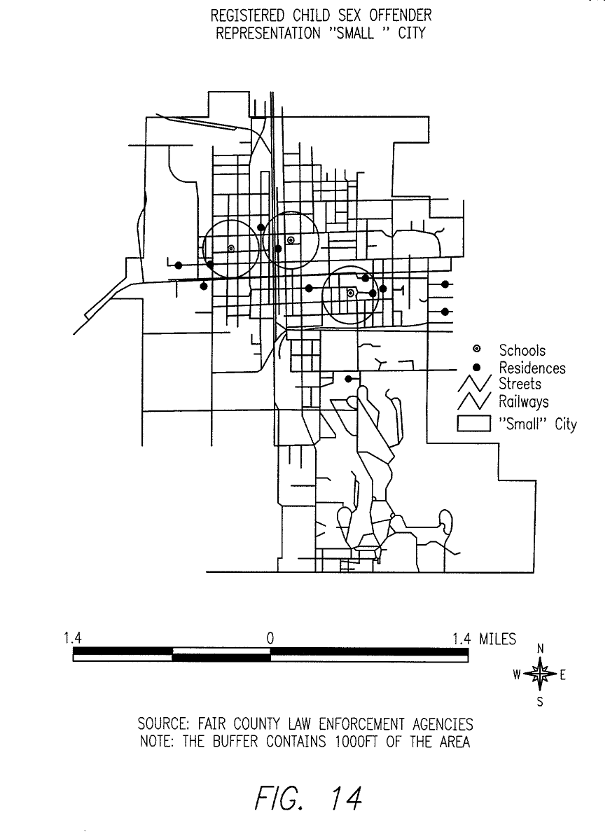

FIG. 13 illustrates a mapping of Hot Spots in a specific embodiment of the present invention. Police departments can make use of computer-mapped crime locations to delineate hot spots, or areas with high concentrations of crime. A presentation that includes highlighting of such areas helps police direct patrols where they are most needed, thereby optimizing the deterrent effect of police presence.

FIG. 14 illustrates a proximity mapping in a specific embodiment of the present invention. The applications of spatial crime analysis extend beyond the production of maps displaying crime locations for police; they provide analytical functions of interest to the general community as well.

The map illustrated in FIG. 14 is of a hypothetical anonymous small town with a population slightly above 6,500, for example. The map indicates the residences of registered child sex offenders whose addresses have been made public by local government. These locations were compared with the locations of the town's schools. A number of 1000-foot buffers were drawn around the schools to make it easier to observe how close the known offenders live to these potential target areas. Four of the twelve total offender residences fall within the buffered school zones on the map, and several of the others live just outside their perimeters. This type of data can be useful for compliance with “Megans law” requirements, for example.

The preceding has been a description of the preferred embodiment of the invention. It will be appreciated that deviations and modifications can be made without departing from the scope of the invention, which is defined by the appended claims.

What is claimed is:

1. A method, comprising:
receiving a first schema database;
forming a virtual schema including at least a portion of a dataset included within the first database;
receiving a first input indicating a criteria;
aggregating data of the database into one or more groupings in accordance with the virtual schema and the first input indicating the criteria; and
displaying one or more indicators associated with the one or more groupings on an n-dimensional presentation.

2. The method of claim 1, further comprising:
receiving a second input indicating one or more regions;
storing the second input as a spatial-object meta data; and
aggregating the groupings based upon the spatial-object meta data.

3. The method of claim 2, further comprising:
displaying one or more indicators associated with the one or more groupings in a region associated therewith on an n-dimensional presentation.

4. The method of claim 2, wherein
the region comprises at least one of:
a polygon,
a circle,
a rectangle,
an ellipse, and
an animal home range.

5. The method of claim 2, wherein:
the second input indicating one or more regions comprises:
at least one of:
an input from a user,
a pre-determined area,
a derivation based upon one or more objects on the n-dimensional presentation, and
a result of a computation.

6. The method of claim 5, wherein:
the pre-determined area comprises at least one of:
a zip code,
an area code,
a census tract,
a Metropolitan Statistical Area (MSA),
a nation state,
a state,
a county,
a municipality,
a latitude, and
a longitude.

7. The method of claim 5, wherein:
the derivation based upon one or more objects on the n-dimensional presentation comprises:
a region within a specified distance of a power line.

8. The method of claim 5, wherein:
the result of a computation comprises:
computing an animal home range, the home range providing a region defined by activities of a target;
defining within the region a first ellipse; and
defining within the region a second ellipse approximately orthogonal to the first ellipse; wherein
an area defined by intersection of the first ellipse and the second ellipse provides a greatest probability of finding the target.

9. The method of claim 8, wherein:
the target comprises at least one of:
a suspect, who perpetrated criminal acts defined by the data,
a customer, who completed transactions in shops defined by the data,
a source of biological material, which caused infections in persons defined by the data.

10. The method of claim 2, wherein:
aggregating the groupings based upon the spatial-object meta data comprises:
checking whether data points fall within a common region, and
if so, aggregating data represented by the data points.

11. The method of claim 3, wherein:
the n-dimensional presentation comprises a map.

12. The method of claim 11, wherein:
displaying one or more indicators further comprises:
determining an x, y coordinate for each region on the map;
displaying at least one indicator associated with the one or more groupings on the map at the x, y coordinate.

13. The method of claim 2, further comprising:
receiving a third input indicating a one or more redefined regions;
storing the third input as a redefined spatial-object meta data; and
aggregating into new groupings based upon the spatial-object meta data.

14. The method of claim 2, further comprising:
redefining the virtual schema based upon the spatial-object meta data.

15. The method of claim 14, wherein:
redefining the virtual schema based upon the spatial-object meta data comprises:
receiving a third input indicating a criteria;
aggregating data of the database into one or more new groupings in accordance with the redefined virtual schema and the third input indicating the criteria; and
displaying one or more indicators associated with the one or more new groupings on an n-dimensional presentation.

16. The method of claim 2, further comprising:
receiving a third input indicating a relationship between a first data point and a second data point on the n-dimensional presentation;
reflecting the relationship in the virtual schema;
aggregating data of the database into one or more new groupings in accordance with the virtual schema; and
displaying one or more indicators associated with the one or more new groupings on an n-dimensional presentation.

17. The method of claim 1, further comprising:
receiving a second database;
forming a virtual schema including at least a portion of a dataset included within at least one of the first database and the second database;
receiving a first input indicating a criteria;
aggregating data of at least one of the first database and the second database into one or more groupings in accordance with the virtual schema and the first input indicating the criteria; and
displaying one or more indicators associated with the one or more groupings on an n-dimensional presentation.

18. The method of claim 1, further comprising:
generating code in accordance with the virtual schema.

19. The method of claim 1, further comprising:
providing customer centric information to a core of customer data within the database in accordance with the virtual schema.

20. A method, comprising:
receiving a first schema database;
forming a virtual schema including at least a portion of a dataset included within the first database;
receiving a first input indicating a criteria;
receiving a second input indicating one or more regions;
aggregating data of the database into one or more groupings in accordance with the virtual schema, the first input indicating the criteria, and the second input indicating the one or more regions of interest; and
displaying one or more indicators associated with the one or more groupings on an n-dimensional presentation.

21. A system, comprising:
a schema builder that generates one or more virtual schemas including at least a portion of data input from a source, and generates mapping rules controlling data movement into a data warehouse;
a metadata repository operative to hold the virtual schemas and mapping rules;
a data warehouse builder;
a spatial-object data repository;
a region checker; and
an n-dimensional presentation;
wherein the data warehouse is defined by at least a portion of the data input, the virtual schemas, the mapping rules, and the analysis functions.

22. The system of claim 21 wherein:
the source comprises at least one of a plurality of on line transaction processing (OLTP) databases.

23. An apparatus, comprising:
means for generating one or more virtual schemas including at least a portion of data input from a source;
means for generating mapping rules controlling data movement into a data warehouse;
means for holding the virtual schemas and mapping rules;
means for generating one or more analysis functions based upon the virtual schemas and data input.

24. A computer program product, comprising:
code for providing a user interface;
code for generating customer data analysis function code;
code for scheduling tasks for managing a data warehouse;
code for pre-processing data for movement into the data warehouse;
code for managing creation of the data warehouse;
code for defining customer data analysis functions;
code for performing data source analysis;
code for planning operations of a customer data analysis environment; and
a computer readable storage medium for holding the codes.

25. A computer program product, comprising:
code for accessing meta data from a repository;
code for translating entities from a meta model into a data schema to form a database;
code for providing customer activity correlation queries with access to a database of a data warehouse;
code for providing customer data analysis functions;
code for providing analysis results to at least one of a plurality of business applications; and
a computer readable storage medium for holding the codes.

26. A customer data analysis report produced according to the method of claim 1.

27. A method, comprising:
providing a focal group, comprising:
at least one of a plurality of core components; and
at least one of a plurality of classification components providing classifications for information relating to the core components; and
providing at least one customized group, comprising:
at least one of a plurality of customer activity components related to the core component; and
at least one of a plurality of activity lookup components related to at least one of the customer activity components;
wherein the focal group and the customized group comprise a reverse star schema meta model.

28. A computer readable storage medium containing information organized according to the method of claim 27.
